(19) United States
(12) Patent Application Publication
(10) Pub. No.: US 2026/0302393 A1
(43) Pub. Date: Oct. 1, 2026

(54) CONTROL DEVICE AND CONTROL METHOD FOR SOLID-STATE BATTERY

(71) Applicant: HONDA MOTOR CO., LTD., Tokyo (JP)

(72) Inventors: Ushio HARADA, Saitama (JP); Kyohei Yamaguchi, Saitama (JP); Katsutoshi Sakurai, Saitama (JP); Fumito Usuzaka, Saitama (JP)

(73) Assignee: HONDA MOTOR CO.,LTD., Tokyo (JP)

(21) Appl. No.: 19/557,156

(22) Filed: Mar. 5, 2026

(30) Foreign Application Priority Data
Mar. 26, 2025 (JP) 2025-051647

(51) Int. Cl. H01M 10/44; H02J 7/82; H02J 7/96

(52) U.S. Cl. CPC H01M 10/44; H02J 7/82; H02J 7/96; H01M 2220/20

(57) ABSTRACT

A control device for a solid-state battery has a processor that controls charging of the solid-state battery by referring to a map which is defined in advance based on an SOC of the solid-state battery and indicates a range in which continuous charging of the solid-state battery is allowed. The processor charges the solid-state battery until the SOC reaches an SOC threshold acquired by referring to the map based on the SOC at the start of charging. When the SOC reaches the SOC threshold, the processor suspends the charging of the solid-state battery during a suspension time acquired by referring to the map based on the SOC threshold. When the suspension time has elapsed, the processor resumes the charging to charge the solid-state battery until the SOC reaches an SOC threshold acquired by referring to the map based on the SOC at the resumption of charging.

### CROSS-REFERENCE TO RELATED APPLICATIONS

This application is based on and claims priority under 35 USC 119 from Japanese Patent Application No. 2025-051647 filed on Mar 26, 2025, the entire content of which is incorporated herein by reference.

### TECHNICAL FIELD

The present disclosure relates to a control device and a control method for a solid-state battery.

### BACKGROUND ART

In recent years, researches and developments have been conducted on a secondary battery which contributes to improvement in energy efficiency in order to allow more people to have access to affordable, reliable, sustainable and advanced energy.

For example, WO2023/228492A1 discloses an EV management system including an electric vehicle (EV) on which a secondary battery is mounted and an EV management device. The EV management system includes a guarantee characteristic estimation unit, a utilization reserve power calculation unit, and an output unit. The guarantee characteristic estimation unit estimates a battery deterioration degree when the EV reaches a preset vehicle life based on information on an operation history of the EV and information on the battery deterioration degree based on an actual measurement value. The utilization reserve power calculation unit calculates a vehicle end-of-lifespan remaining capacity that is a charge/discharge capacity until the EV reaches a vehicle lifespan and a remaining lifespan capacity that is a charge/discharge capacity until a battery reaches a battery lifespan based on an estimation result by the guarantee characteristic estimation unit, and calculates a reserve power capacity of the battery in a case where the remaining lifespan capacity is larger than the vehicle end-of-lifespan remaining capacity. The output unit outputs a calculation result of the utilization reserve power calculation unit as a utilization reserve power.

Among secondary batteries, a solid-state battery using a solid electrolyte is particularly attracting attention because the solid electrolyte is nonflammable and thus is excellent in terms of improving safety and has a higher energy density when a Li metal negative electrode or a Li alloy negative electrode is used.

In research and development related to suppression of deterioration of a solid-state battery, unlike a liquid-based battery in which an electrolyte is a liquid, it is necessary to consider a state of an interface between the Li metal negative electrode and a solid electrolyte layer. At the interface between the Li metal negative electrode and the solid electrolyte layer, distribution of dissolution and precipitation reaction of lithium ions occurs unevenly due to continuous charging and discharging of the solid-state battery, and voids are formed at the interface, which causes deterioration of the solid-state battery.

### SUMMARY OF INVENTION

The present disclosure provides a control device and a control method for a solid-state battery capable of suppressing deterioration of the solid-state battery by appropriately controlling charging of the solid-state battery.

A first aspect of the present disclosure is a control device for a solid-state battery, the control device having:

a processor configured to control charging of the solid-state battery by referring to a map that is defined in advance based on an SOC of the solid-state battery and indicates a range in which continuous charging of the solid-state battery is allowed; and

a memory storing the may, in which

in a case of charging the solid-state battery by an external power supply, the processor executes processing of:

charging the solid-state battery until the SOC of the solid-state battery reaches an SOC threshold acquired by referring to the map based on the SOC at the start of charging;

when the SOC reaches the SOC threshold, suspending the charging of the solid-state battery during a suspension time acquired by referring to the map based on the SOC threshold; and

when the suspension time has elapsed, resuming the charging of the solid-state battery, and charging the solid-state battery until the SOC reaches an SOC threshold acquired by referring to the map based on the SOC at the resumption of charging.

A second aspect of the present disclosure is a control method for a solid-state battery, the control method of controlling charging of the solid-state battery by an external power supply by referring to a map that is defined in advance based on an SOC of the solid-state battery and indicates a range in which continuous charging of the solid-state battery is allowed, the control method including:

charging the solid-state battery until the SOC of the solid-state battery reaches an SOC threshold acquired by referring to the map based on the SOC at the start of charging;

when the SOC reaches the SOC threshold, suspending the charging of the solid-state battery during a suspension time acquired by referring to the map based on the SOC threshold; and

when the suspension time has elapsed, resuming the charging of the solid-state battery, and charging the solid-state battery until the SOC reaches an SOC threshold acquired by referring to the map based on the SOC at the resumption of charging.

According to the aspects of the present disclosure, deterioration of the solid-state battery can be suppressed by appropriately controlling charging of the solid-state battery.

### BRIEF DESCRIPTION OF DRAWINGS

Exemplary embodiment(s) of the present invention will be described in detail based on the following figures, wherein:

FIG. 1 is a cross-sectional view of a solid-state battery 1 according to an embodiment of the present disclosure;

FIG. 2 is a perspective view of a solid-state battery implemented as a battery cell of a lamination type;

FIG. 3 is a block diagram of a vehicle including the solid-state battery and a control device;

FIG. 4 illustrates a charge control map when a deterioration degree of the solid-state battery is small;

FIG. 5 illustrates a charge control map when the deterioration degree of the solid-state battery is medium;

FIG. 6 illustrates a charge control map when the deterioration degree of the solid-state battery is large;

FIG. 7 illustrates a flowchart of processing of charge control of the solid-state battery;

FIG. 8 is a schematic cross-sectional view of a battery module in which a plurality of solid-state batteries are laminated; and

FIG. 9 illustrates a discharge control map when the deterioration degree of the solid-state battery is large.

### DESCRIPTION OF EMBODIMENTS

Hereinafter, an embodiment of a control device and a control method for a solid-state battery according to the present disclosure will be described with reference to the accompanying drawings. First, a structure of the solid-state battery will be described.

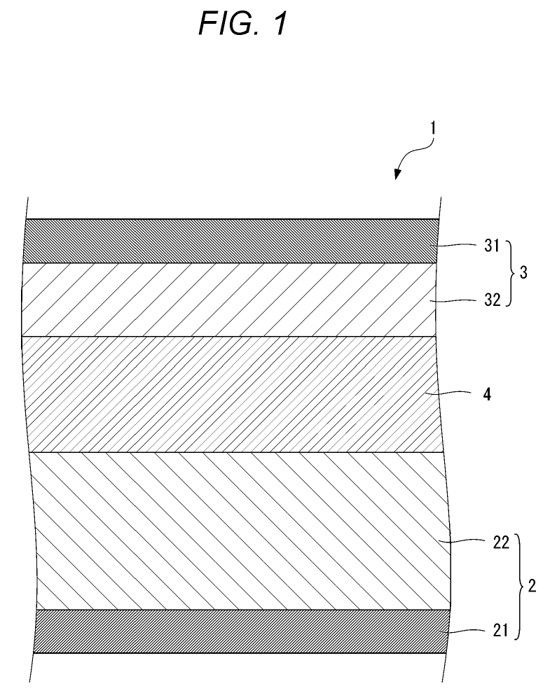

FIG. 1 is a cross-sectional view of a solid-state battery 1. The solid-state battery 1 includes a positive electrode layer 2, a negative electrode layer 3, and a solid electrolyte layer 4 disposed between the positive electrode layer 2 and the negative electrode layer 3. The positive electrode layer 2, the solid electrolyte layer 4, and the negative electrode layer 3 are laminated in this order. The solid-state battery 1 is not particularly limited, and is a lithium ion secondary battery.

The positive electrode layer 2 includes a positive electrode current collector 21 and a positive electrode active material layer 22 laminated on each other. The positive electrode current collector 21 has a function of collecting current from the positive electrode active material layer 22. The positive electrode current collector 21 preferably includes at least one material having high conductivity. Examples of a highly conductive material include aluminum, an aluminum alloy, stainless steel, nickel, iron, and titanium. Examples of a shape of the positive electrode current collector 21 include a foil shape, a plate shape, a mesh shape, a nonwoven fabric shape, and a foam shape. A surface of the positive electrode current collector 21 may be roughened in order to enhance adhesion to the positive electrode active material layer 22.

The positive electrode active material layer 22 contains, for example, a positive electrode active material and a solid electrolyte. The positive electrode active material layer 22 is formed by applying a positive electrode slurry, which is generated by kneading the positive electrode active material and the solid electrolyte together with a dispersion medium, to the positive electrode current collector 21, and drying the positive electrode slurry. The dispersion medium includes conductive assistance, a binder, and a solvent, and each material may be similar as that used in a general solid-state battery.

The positive electrode active material may be similar as that used for a positive electrode material of a general solid-state battery. Examples of the positive electrode active material include lithium-cobalt composite oxide, lithium-nickel composite oxide, lithium-nickel-cobalt composite oxide, lithium-nickel-manganese composite oxide, lithium-nickel-cobalt-manganese composite oxide, and lithium-nickel-cobalt-aluminum composite oxide. Specific examples of the positive electrode active material include LiCoO₂ and LiNiₚMn_{q}CoᵣO₂ (p+q+ r=1), LiNiₚAl_{q}CoᵣO₂ (p+q+r=1). The positive electrode active material may be a material containing a metal element such as Cr, Fe, V, Mg, Ca, Na, Ti, Zr, Nb, Mo, W, Cu, Zn, Ga, In, Sn, La, and Ce.

The solid electrolyte contained in the positive electrode active material layer 22 may be similar as that used in a general solid-state battery, and examples thereof include a similar solid electrolyte as a solid electrolyte (described later) contained in the solid electrolyte layer 4. Examples of the solid electrolyte contained in the positive electrode active material layer 22 include a sulfide-based solid electrolyte.

The negative electrode layer 3 includes a negative electrode current collector 31 and a negative electrode active material layer 32 laminated on each other. The negative electrode current collector 31 has a function of collecting current from the negative electrode active material layer 32. The negative electrode current collector 31 preferably includes at least one material having high conductivity. Examples of a highly conductive material include copper, nickel, and stainless steel. Examples of a shape of the negative electrode current collector 31 include a foil shape, a plate shape, a mesh shape, a nonwoven fabric shape, and a foam shape. A surface of the negative electrode current collector 31 may be roughened in order to enhance adhesion to the negative electrode active material layer 32.

The negative electrode active material layer 32 contains, for example, a negative electrode active material and a solid electrolyte. The negative electrode active material layer 32 is formed by applying a negative electrode slurry, which is generated by kneading the negative electrode active material and the solid electrolyte together with a dispersion medium, to the negative electrode current collector 31, and drying the negative electrode slurry.

The negative electrode active material may be similar as that used for a negative electrode material of a general solid-state battery. Examples of the negative electrode active material include lithium metal, lithium alloys, silicon-based active materials such as Si and Si alloys, lithium transition metal oxides such as lithium titanate (Li₄Ti₅O₁₂), transition metal oxides such as TiO₂, Nb₂O₃ and WO₃, metal sulfides, metal nitrides, carbon materials such as graphite, soft carbon and hard carbon, and metallic indium.

The solid electrolyte contained in the negative electrode active material layer 32 may be similar as that used in a general solid-state battery, and examples thereof include a similar solid electrolyte as the solid electrolyte (described later) contained in the solid electrolyte layer 4. Examples of the solid electrolyte contained in the negative electrode active material layer 32 include a sulfide-based solid electrolyte.

The solid electrolyte layer 4 is formed between the positive electrode layer 2 and the negative electrode layer 3. The solid electrolyte layer 4 may be formed in a plurality of layers. A material constituting the solid electrolyte layer 4 may be similar as that used for a solid electrolyte of a general solid-state battery, and examples thereof include a sulfide-based solid electrolyte material. The sulfide-based solid electrolyte material usually contains a metal element (M) serving as a conducting ion and sulfur (S). Examples of the M include Li, Na, K, Mg, and Ca, and among them, Li is preferable. In particular, the sulfide-based solid electrolyte material preferably contains Li, A (A is at least one selected from the group consisting of P, Si, Ge, Al, and B), and S, and among them, A is more preferably phosphorus (P). Further, the sulfide-based solid electrolyte material may contain halogen such as Cl, Br, or I. This is because ion conductivity is improved by containing halogen. The sulfide-based solid electrolyte material may contain O.

The solid-state battery 1 may further include an intermediate layer disposed between the negative electrode layer 3 and the solid electrolyte layer 4. For example, when the solid-state battery 1 is a lithium metal secondary battery using a negative electrode active material as a lithium metal, the intermediate layer has a function of uniformly depositing the lithium metal. A material constituting the intermediate layer is not particularly limited, and examples thereof include a metal that can be alloyed with lithium and amorphous carbon.

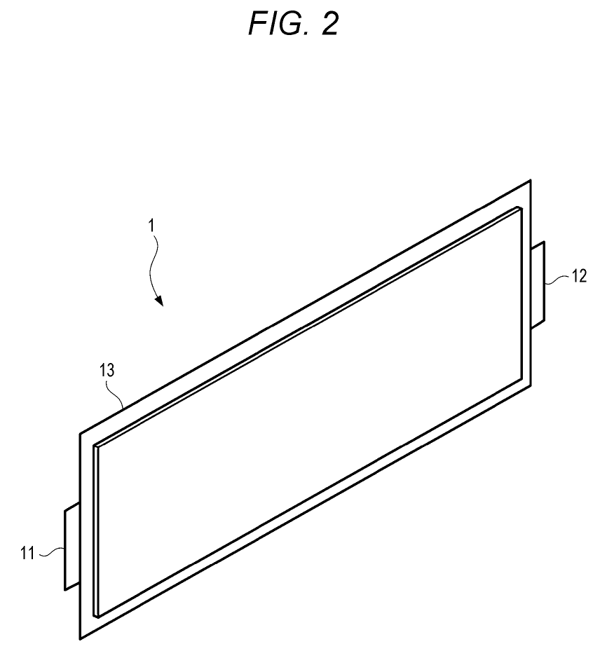

As illustrated in FIG. 2, in the solid-state battery 1, the laminated positive electrode layer 2, negative electrode layer 3, and solid electrolyte layer 4 are accommodated in a sheath 13. The sheath 13 is, for example, a lamination film, and the solid-state battery 1 is implemented as a battery cell of a lamination type. The solid-state battery 1 includes a positive electrode tab lead 11 connected to the positive electrode current collector 21 and a negative electrode tab lead 12 connected to the negative electrode current collector 31.

A plurality of solid-state batteries 1 are mounted while being connected in series and/or in parallel on a moving object using a motor as a drive source, such as an electric vehicle or a plug-in hybrid vehicle, and supply power to the motor. When using the moving object, the solid-state battery 1 is repeatedly charged and discharged (input and output). For example, when the moving object moves, the solid-state battery 1 continues to supply a large amount of power to the motor, and is continuously discharged. Similarly, when the solid-state battery 1 is charged, the solid-state battery 1 continues to receive a large amount of power from an external power supply and is continuously charged. When the solid-state battery 1 is continuously charged or discharged, continuous intercalation and deintercalation reactions of lithium ions occur in the positive electrode layer 2 and the negative electrode layer 3. Such intercalation and deintercalation reactions are unevenly distributed depending on a structure, a temperature, a restraint pressure, a partial deterioration, and the like of the solid-state battery 1.

As an example, when the negative electrode active material is a lithium metal or a lithium alloy, in the negative electrode layer 3, a dissolution and precipitation reaction of lithium metal occurs in situ, and movement and diffusion of the lithium metal in the negative electrode layer 3 hardly occur. Therefore, when uneven distribution of the intercalation and deintercalation reaction in the positive electrode layer 2 is large, the dissolution and precipitation reaction of lithium metal in the negative electrode layer 3 as a counter electrode becomes non-uniform, and voids are formed in the vicinity of an interface between the negative electrode layer 3 and the solid electrolyte layer 4. When the solid-state battery 1 is repeatedly charged and discharged, the voids expand and an effective interface area decreases. Accordingly, a capacity of the solid-state battery 1 decreases, and deterioration accelerates. The formation of such voids at the interface is a problem unique to solid-state batteries, unlike liquid-based batteries in which an electrolyte is liquid.

In a control method for the solid-state battery 1 according to the present embodiment, control is executed to suspend (temporarily stop) charging at an appropriate timing during charging of the solid-state battery 1 and resume charging after a predetermined suspension time elapses. Even after resuming charging, charging is suspended again at an appropriate timing, that is, charging and suspension are repeated to prevent continuous charging for a long time. By such a control method, lithium ion distribution in the positive electrode layer 2 is equalized during the charging suspension, and uneven distribution of a reaction in the positive electrode layer 2 during charging is suppressed. Accordingly, deterioration of the solid-state battery 1 can be suppressed.

Hereinafter, specific contents of the control method for the solid-state battery 1 according to the present embodiment and a control device 110 that executes the control method will be described in detail. Hereinafter, an example in which the solid-state battery 1 is mounted on the electric vehicle 100 (an example of the moving object described above) and various types of processing of the control method according to the present embodiment are executed by the control device 110 of the electric vehicle 100 will be described.

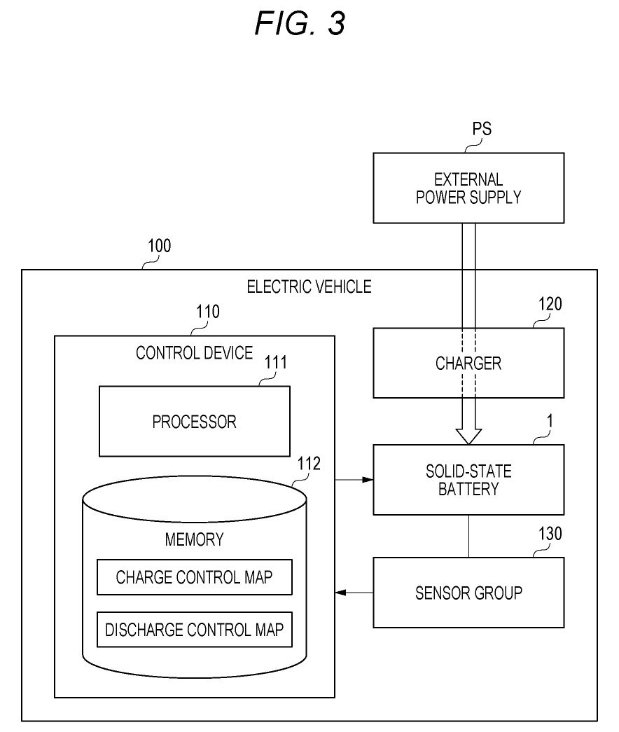

As illustrated in FIG. 3, the electric vehicle 100 includes the solid-state battery 1 and the control device 110 that controls charging and discharging of the solid-state battery 1.

The electric vehicle 100 is configured to charge the solid-state battery 1 by being electrically connected (plugged in) to an external power supply PS connected to an external power system such as a commercial power supply. Power supplied from the external power supply PS may be either AC power or DC power. The electric vehicle 100 is provided with a charger 120 and a sensor group 130 that detects various types of information of the solid-state battery 1. The charger 120 converts a current introduced from the external power supply PS, for example, AC power during normal charging into DC power, and outputs the converted DC power to the solid-state battery 1. The sensor group 130 includes, for example, a voltage sensor that detects an input and output voltage of the solid-state battery 1, a current sensor that detects an input and output current of the solid-state battery 1, and a temperature sensor that measures a temperature of the solid-state battery 1.

The control device 110 is, for example, an electronic control unit (ECU) including a processor 111 and a memory 112. The processor 111 is implemented as one or more electric circuits in which circuit elements such as semiconductor elements are combined. The memory 112 functions as a storage unit and includes a random access memory (RAM) necessary for an operation of the processor 111, a read only memory (ROM) that stores programs and data, and the like. The memory 112 stores a charge control map.

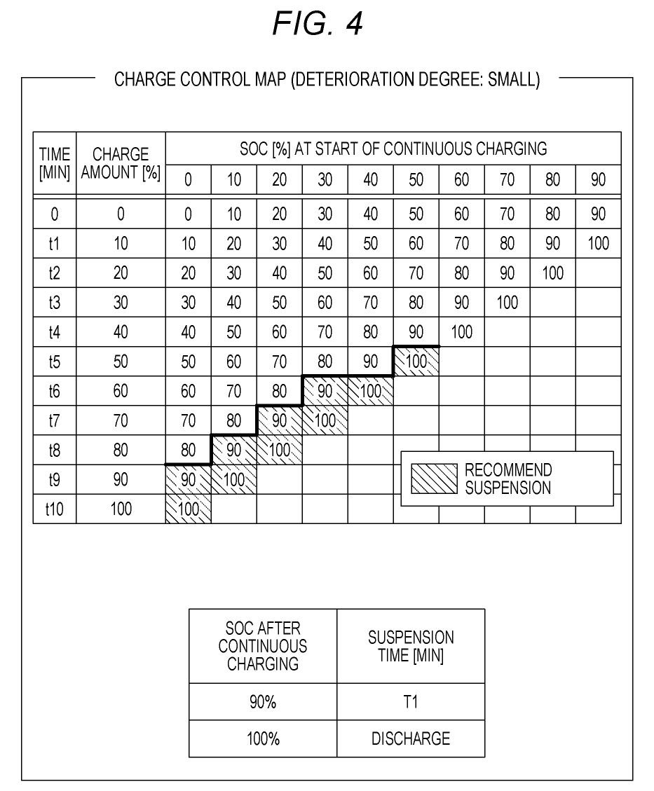

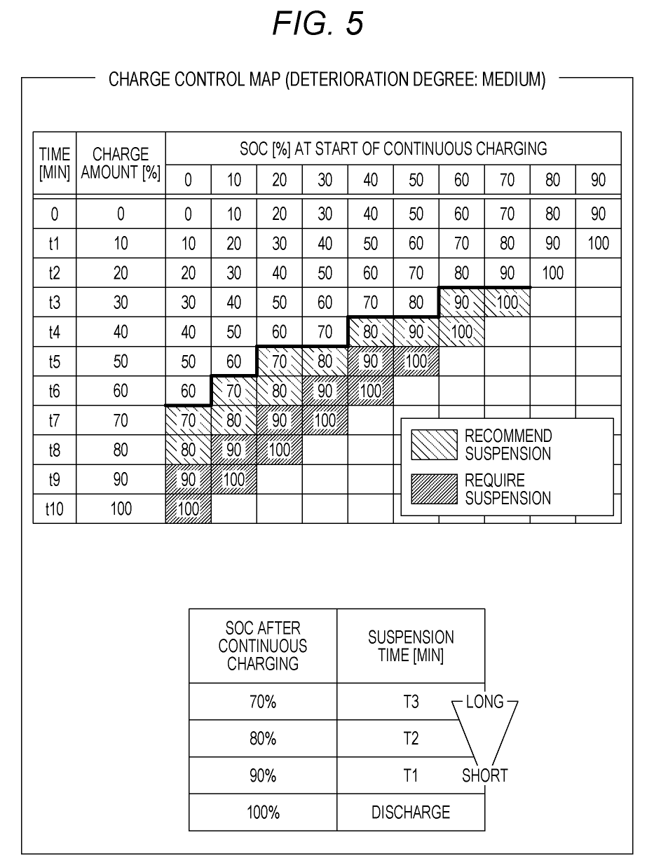

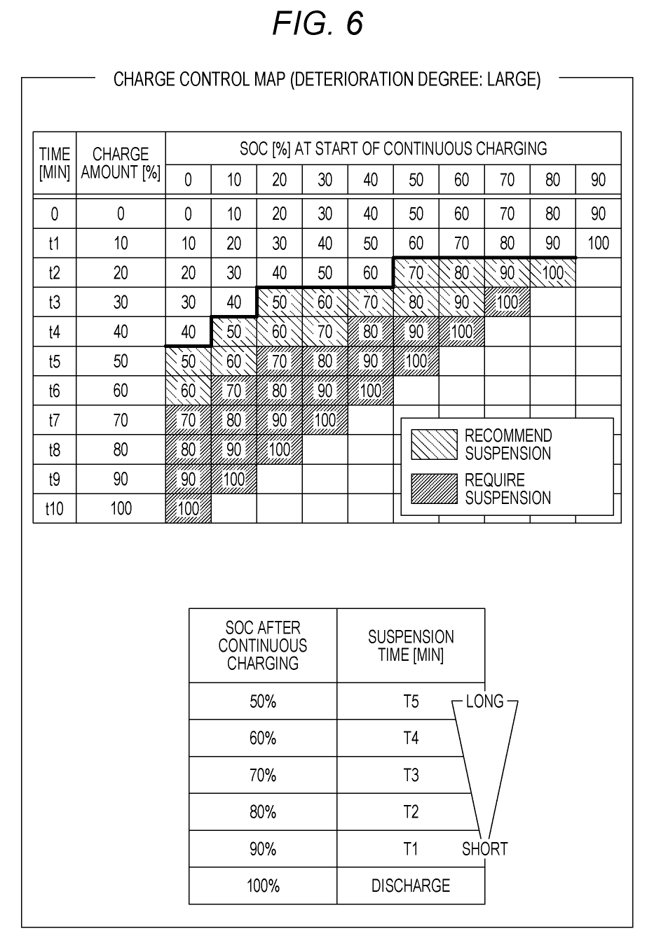

FIGS. 4 to 6 illustrate examples of the charge control map stored in the memory 112. The memory 112 stores a plurality of (here, three) charge control maps corresponding to a deterioration state of the solid-state battery 1. The charge control map illustrated in FIG. 4 is used when a deterioration degree of the solid-state battery 1 is small, the charge control map illustrated in FIG. 5 is used when deterioration of the solid-state battery 1 progresses and the deterioration degree is medium, and the charge control map illustrated in FIG. 6 is used when the deterioration of the solid-state battery 1 further progresses and the deterioration degree is large. The processor 111 selects a charge control map to be referred to according to the deterioration state of the solid-state battery 1.

The charge control map is defined in advance based on a State Of Charge (SOC) indicating a state of charge of the solid-state battery 1, and indicates a range in which continuous charging of the solid-state battery 1 is allowed. In the present specification, continuous charging (also referred to as continuous charging) refers to continuing charging without any suspension in the middle.

The charge control map includes information indicating a relationship between the SOC at the start of charging and an upper limit value (SOC threshold) of the SOC allowed in the case of continuous charging as illustrated in an upper map in each figure, and information indicating a relationship between the SOC after continuous charging and a suspension time as illustrated in a lower map. In the upper map, a range of the SOC without hatching is a range in which continuous charging is allowed, a range of the SOC with coarse hatching is a range in which suspension for continuous charging is recommended, and a range of the SOC with fine hatching is a range in which suspension for continuous charging is strongly required. The lower map illustrates the suspension time when the SOC reaches a range of "recommend suspension" due to the continuous charging. The suspension time varies depending on the SOC after the continuous charging. By suspending the charging when the SOC of the solid-state battery 1 exceeds an allowable range of the continuous charging, the lithium ion distribution in the positive electrode layer 2 can be equalized during the suspension.

Control based on the charge control map will be specifically described with reference to FIG. 6 using an example (first example). A case where the SOC of the solid-state battery 1 at the start of charging is 10% and a target SOC is 100% will be described. According to the charge control map in FIG. 6, when the SOC of the solid-state battery 1 at the start of charging is 10%, continuous charging is allowed until the SOC reaches 50%. This SOC 50% is the SOC threshold for the continuous charging when the SOC at the start of charging is 10%. The processor 111 charges the solid-state battery 1 until the SOC reaches 50%. Since charging suspension is recommended when the SOC reaches 50%, the processor 111 sets the suspension time to T5 (for example, 90 minutes) by referring to the charge control map based on SOC 50% after the continuous charging, and suspends charging of the solid-state battery 1 during the suspension time T5.

When the suspension time T5 has elapsed, the processor 111 resumes charging of the solid-state battery 1. According to the charge control map in FIG. 6, when the SOC of the solid-state battery 1 at the start of charging is 50%, continuous charging is allowed until the SOC reaches 70%. This SOC 70% is the SOC threshold for the continuous charging when the SOC at the resumption of charging is 50%. After resuming the charging of the solid-state battery 1, the processor 111 charges the solid-state battery 1 until the SOC reaches 70%. When the SOC reaches 70%, the processor 111 sets the suspension time to T3 (for example, 54 minutes) by referring to the charge control map based on SOC 70% after the continuous charging, and suspends charging of the solid-state battery 1 during the suspension time T3. Comparing a case of charging until the SOC becomes 10% to 50% and a case of charging until the SOC becomes 50% to 70%, the former case has a larger charge amount and a longer charging time. Therefore, the suspension time T3 may be shorter than the suspension time T5. Thus, when the charging is suspended a plurality of times, the suspension time is set to be shorter as the number of times of suspension increases.

Thereafter, the processor 111 repeats the continuous charging and the suspension in the same manner until the SOC of the solid-state battery 1 becomes 100% which is the target SOC, and ends the charging when the SOC becomes 100%. The processor 111 may end the charging and start discharging when the SOC becomes 100% as illustrated in the lower map in each figure.

Next, another example (second example) will be described with reference to FIG. 5. A case where the SOC of the solid-state battery 1 at the start of charging is 20% and the target SOC is 80% will be described. According to the charge control map in FIG. 5, when the SOC of the solid-state battery 1 at the start of charging is 20%, continuous charging is allowed until the SOC reaches 70%. This SOC 70% is the SOC threshold for the continuous charging when the SOC at the start of charging is 20%. The processor 111 charges the solid-state battery 1 until the SOC reaches 70%. Since charging suspension is recommended when the SOC reaches 70%, the processor 111 sets the suspension time to T3 (for example, 54 minutes) by referring to the charge control map based on SOC 70% after the continuous charging, and suspends charging of the solid-state battery 1 during the suspension time T3.

When the suspension time T3 has elapsed, the processor 111 resumes charging of the solid-state battery 1. According to the charge control map in FIG. 5, when the SOC of the solid-state battery 1 at the start of charging is 70%, continuous charging is allowed until the SOC reaches 100%. This SOC 100% is the SOC threshold for the continuous charging when the SOC at the resumption of charging is 70%. Since the target SOC by current charging is 80%, the processor 111 ends the charging when the SOC becomes 80% after the charging is resumed.

In the second example, when the SOC reaches the SOC threshold 70% from 20%, the processor 111 may select to continue charging of the solid-state battery 1 until the SOC reaches the target SOC 80% without suspending the charging. Although the charging is performed within a range in which charging suspension is recommended, the SOC can reach the target SOC in a short time without suspending. Such selection of whether to continue the charging is executed by the processor 111, for example, in consideration of a scheduled start time of use of the electric vehicle 100. Similarly, in the second example, when the target SOC is 100%, when the SOC reaches the SOC threshold 70% from 20%, the processor 111 may select to continue charging of the solid-state battery 1 until the SOC reaches the target SOC 100% without suspending the charging. In this case, the charging is performed within a range in which the charging suspension is strongly required, but the SOC can reach the target SOC in a short time without suspending.

When the charging of the solid-state battery 1 is continued without suspending the charging, the processor 111 preferably stores in the memory 112 that the solid-state battery 1 has been charged within a range in which charging suspension is recommended and/or a range in which charging suspension is strongly required. Such information can be used to estimate the deterioration state of the solid-state battery 1. For example, while the electric vehicle 100 is repeatedly used day by day, the processor 111 may accumulate the number of times the charging of the solid-state battery 1 is continued without suspending the charging in the memory 112, and estimate the deterioration state of the solid-state battery 1 based on the number of times accumulated in the memory 112. Accordingly, accuracy of deterioration estimation of the solid-state battery 1 can be improved.

Comparing the charge control maps in FIGS. 4 to 6, the range in which continuous charging of the solid-state battery 1 is allowed is the widest in the charge control map in FIG. 4 used when the deterioration degree is small, and the narrowest in the charge control map in FIG. 6 used when the deterioration degree is large. When the SOC thresholds are specifically compared, the SOC threshold in the charge control map in FIG. 4 is 90% or more, the SOC threshold in the charge control map in FIG. 5 is 70% or more, and the SOC threshold in the charge control map in FIG. 6 is 50% or more. That is, as deterioration of the solid-state battery 1 progresses, a frequency of the recommendation of suspension during the continuous charging can be increased, and acceleration of the deterioration can be suppressed.

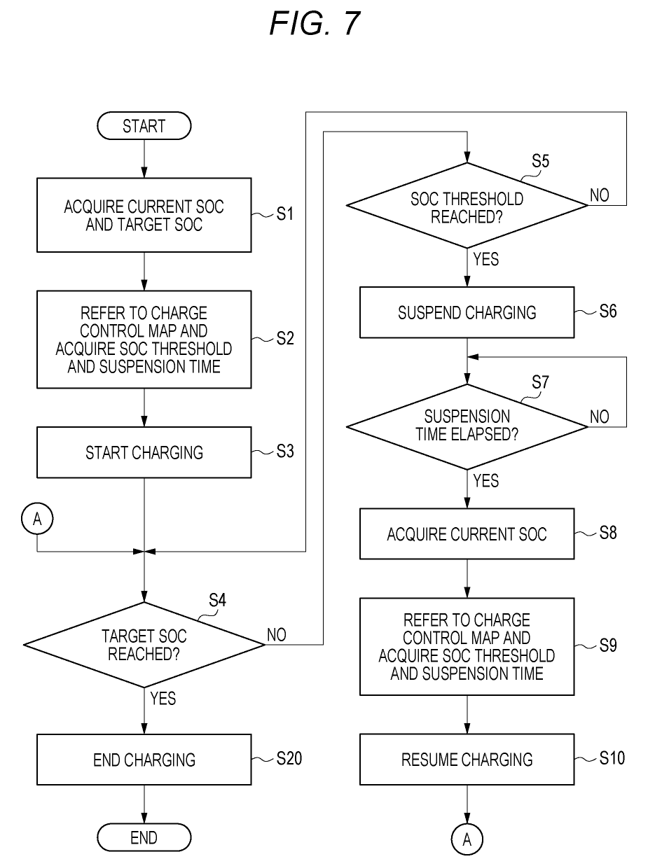

FIG. 7 illustrates an example of a flowchart of processing of charge control of the solid-state battery 1 executed by the processor 111 of the control device 110. For example, the processor 111 starts the processing of this flowchart when the external power supply PS is electrically connected (plugged in) to the electric vehicle 100.

The processor 111 first acquires a current SOC and a target SOC of the solid-state battery 1 (step S1). The target SOC is, for example, set by a user of the electric vehicle 100 or set based on a use schedule of the electric vehicle 100. Next, the processor 111 refers to the charge control map based on the current SOC (that is, the SOC at the start of charging) and acquires a SOC threshold (that is, the SOC after continuous charging) corresponding to the SOC at the start of charging and a suspension time corresponding to the SOC threshold (step S2). Then, the processor 111 starts charging the solid-state battery 1 (step S3).

The processor 111 determines whether the SOC of the solid-state battery 1 has reached the target SOC during the charging (step S4). If the SOC reaches the target SOC (step S4: YES), the processor 111 ends the charging (step S20). If the SOC does not reach the target SOC (step S4: NO), the processor 111 determines whether the SOC reaches the SOC threshold, and if the SOC does not reach the SOC threshold (step S5: NO), the processing returns to step S4 again.

If the SOC reaches the SOC threshold (step S5: YES), the processor 111 suspends the charging of the solid-state battery 1 during the suspension time (step S6). The processor 111 determines whether the suspension time has elapsed while charging is suspended (step S7). If the suspension time has not elapsed (step S7: NO), the processor 111 monitors a time until the suspension time elapses.

If the suspension time has elapsed (step S7: YES), the processor 111 acquires a current SOC (step S8). Next, the processor 111 refers to the charge control map based on the current SOC (that is, the SOC at the resumption of charging), and acquires a SOC threshold corresponding to the SOC when the charging is resumed and a suspension time corresponding to the SOC threshold (step S9). Then, the processor 111 resumes the charging of the solid-state battery 1 (step S10), and returns to step S4. The processor 111 repeats steps S4 to S10 until the SOC reaches the target SOC.

As described above, the processor 111 refers to the charge control map which is defined in advance, performs charging up to a range in which the continuous charging is allowed, and suspends the charging when the charging is out of the range. Then, the processor 111 refers to the charge control map after the charging is resumed, performs the charging within the range in which the continuous charging is allowed, and suspends the charging when the charging is out of the range. Since a timing and the suspension time of the charging suspension are appropriately set by the charge control map based on the SOC, it is possible to equalize the lithium ion distribution in the positive electrode layer 2 during the charging suspension while avoiding excessive charging suspension. As a result, deterioration of the solid-state battery 1 can be suppressed.

Since the processor 111 selects the charge control map to be referred to according to the deterioration state of the solid-state battery 1, it is possible to appropriately set the timing and the suspension time of the charging suspension according to the deterioration state of the solid-state battery 1, and to further suppress the deterioration of the solid-state battery 1.

Here, the deterioration state of the solid-state battery 1 depends on, for example, an ion conductivity of the positive electrode layer 2 of the solid-state battery 1, a cumulative use time of the solid-state battery 1, and/or an open circuit voltage of the solid-state battery 1 detected by the voltage sensor in the sensor group 130. Based on this, the processor 111 may select the charge control map to be referred to, for example, according to the ion conductivity, the cumulative use time, and/or the open circuit voltage. Accordingly, the timing and the suspension time of the charging suspension can be appropriately set, and the deterioration of the solid-state battery 1 can be further suppressed.

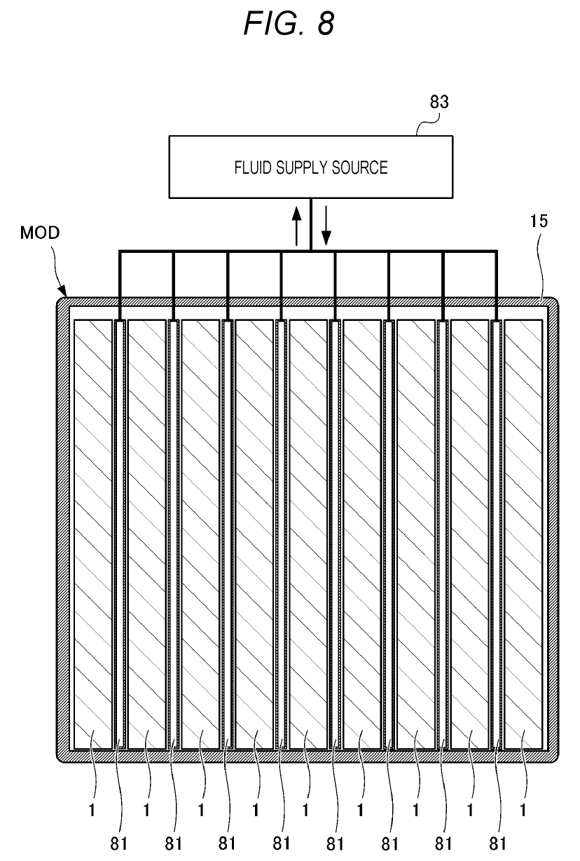

FIG. 8 is a schematic cross-sectional view of a battery module MOD in which a plurality of solid-state batteries 1 implemented as battery cells of a lamination type are laminated. The battery module MOD includes a frame member 15 that restrains the plurality of laminated solid-state batteries 1, and an absorber 81 provided between two adjacent solid-state batteries 1.

The absorber 81 is, for example, a pouch that is a flat bag-shaped packaging material having insulating properties into which fluids such as a gas or a liquid can flow. A plurality of absorbers 81 may be provided in the battery module MOD as illustrated in FIG. 8, or only one absorber 81 may be provided in the battery module MOD. The absorber 81 may be provided between the frame member 15 and the solid-state battery 1.

The processor 111 may increase a restraint pressure of the solid-state battery 1 while the charging of the solid-state battery 1 is suspended. Specifically, the absorber 81 is connected to a fluid supply source 83 including a pump or the like provided outside the battery module MOD, and a fluid flows into and out of an interior of the absorber 81. When the fluid flows into the absorber 81, the absorber 81 expands to increase a restraining force of the frame member 15 on the solid-state battery 1. When the fluid flows out of the absorber 81, the absorber 81 contracts to reduce the restraining force of the frame member 15 on the solid-state battery 1.

When the restraint pressure of the solid-state battery 1 is increased by the absorber 81 while the charging of the solid-state battery 1 is suspended, contact at an interface between the electrode layers (the positive electrode layer 2 and the negative electrode layer 3) and the solid electrolyte layer 4 is good. As a result, uneven distribution of lithium ion reactions is reduced, and deterioration of the solid-state battery 1 can be further suppressed.

The processor 111 may adjust a temperature of the solid-state battery 1 while the charging of the solid-state battery 1 is suspended. Specifically, the temperature of the solid-state battery 1 is adjusted by adjusting the temperature of the fluid flowing into the absorber 81 described above. By appropriately adjusting the temperature of the solid-state battery 1 during the charging suspension, movement of lithium ions can be promoted to sufficiently equalize the lithium ion distribution, and the deterioration of the solid-state battery 1 can be further suppressed.

Returning to FIG. 3, the memory 112 of the control device 110 may further store a discharge control map. The discharge control map is defined based on the SOC of the solid-state battery 1 and indicates a range in which continuous discharging of the solid-state battery 1 is allowed. The processor 111 is configured to control discharge of the solid-state battery 1 by referring to the discharge control map.

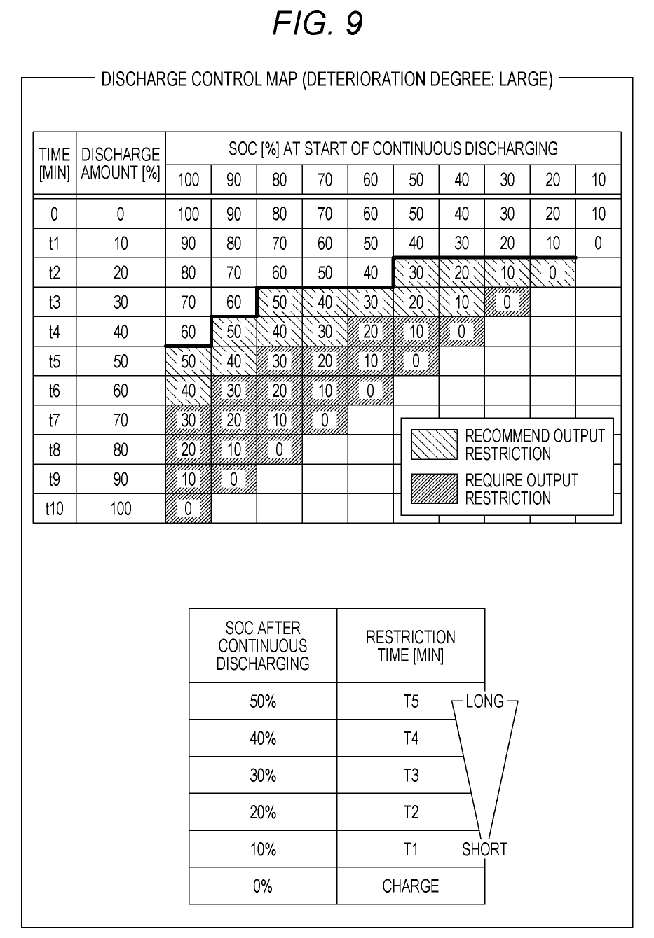

FIG. 9 illustrates an example of the discharge control map stored in the memory 112. The discharge control map includes information indicating a relationship between the SOC at the start of discharging and a lower limit value (SOC threshold) of the SOC allowed in the case of continuous discharging as illustrated in an upper map, and information indicating a relationship between the SOC after the continuous discharging and a restriction time for restricting an output of the solid-state battery 1 as illustrated in a lower map. An output restriction means, for example, reducing the output of the solid-state battery 1. In the upper map, a range of the SOC without hatching is a range in which continuous discharging is allowed, a range of the SOC with coarse hatching is a range in which the output restriction of the solid-state battery 1 is recommended, and a range of the SOC with fine hatching is a range in which the output restriction is strongly required. The lower map illustrates the restriction time when the SOC reaches a range of "recommend output restriction" due to continuous discharging. The restriction time varies depending on the SOC after the continuous discharging. By performing the output restriction when the SOC of the solid-state battery 1 exceeds an allowable range of the continuous discharging, it is possible to suppress a progress of uneven distribution of lithium ion reactions in the positive electrode layer 2.

The discharge control map will be specifically described with an example. A case where the SOC of the solid-state battery 1 at the start of discharging is 100% will be described. According to the discharge control map in FIG. 9, when the SOC of the solid-state battery 1 at the start of discharging is 100%, continuous discharging is allowed until the SOC reaches 50%. This SOC 50% is the SOC threshold for the continuous discharging when the SOC at the start of discharging is 100%. The processor 111 allows the solid-state battery 1 to be discharged until the SOC reaches 50%. Since the output restriction of the solid-state battery 1 is recommended when the SOC reaches 50%, the processor 111 sets the restriction time to T5 (for example, 90 minutes) by referring to the discharge control map based on the SOC 50% after the continuous discharging, and reduces an output of the solid-state battery 1 during the restriction time T5.

When the restriction time T5 elapses, the processor 111 releases the output restriction of the solid-state battery 1. According to the discharge control map, when the SOC of the solid-state battery 1 at the start of discharging is 50%, continuous discharging is allowed until the SOC reaches 30%. This SOC 30% is the SOC threshold for the continuous discharging when the SOC at the time of releasing the output restriction is 50%. After the restriction is released, the processor 111 allows the solid-state battery 1 to discharge until the SOC reaches 30%. When the SOC reaches 30%, the processor 111 sets the restriction time to T3 (for example, 54 minutes) by referring to the discharge control map based on the SOC 30% after the continuous discharging, and decreases the output of the solid-state battery 1 during the restriction time T3. The processor 111 ends the discharging and may start charging when the SOC becomes 0% as illustrated in the lower map in FIG. 9.

Thus, in the case of discharging the solid-state battery 1, the processor 111 allows the solid-state battery 1 to be discharged until the SOC of the solid-state battery 1 reaches the SOC threshold acquired by referring to the discharge control map based on the SOC at the start of discharging. Then, when the SOC reaches the SOC threshold, the processor 111 restricts the output of the solid-state battery 1 for the restriction time acquired by referring to the discharge control map based on the SOC threshold. Since a timing and the restriction time of the output restriction are appropriately set by the discharge control map based on the SOC, it is possible to suppress the uneven distribution of lithium ion reactions in the positive electrode layer 2 from progressing while avoiding excessive restriction of discharge.

Similarly to the charge control map, a plurality of discharge control maps may be provided. The discharge control map illustrated in FIG. 9 is used when the deterioration degree is large. The processor 111 may select the discharge control map to be referred to according to the deterioration state of the solid-state battery 1.

Although an embodiment of the present disclosure has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiment may be freely combined without departing from the gist of the invention.

In the present specification, at least the following matters are described. In the parentheses, the corresponding constituent elements and the like in the above embodiment are shown as an example, and the present invention is not limited thereto.

(1) A control device (control device 110) for a solid-state battery (solid-state battery 1), the control device including:

a processor (processor 111) configured to control charging of the solid-state battery by referring to a map (charge control map) that is defined in advance based on an SOC of the solid-state battery and indicates a range in which continuous charging of the solid-state battery is allowed; and

a memory (memory 112) storing the map, in which

in a case of charging the solid-state battery by an external power supply (external power supply PS), the processor executes processing of:

charging the solid-state battery until the SOC of the solid-state battery reaches an SOC threshold acquired by referring to the map based on the SOC at the start of charging;

when the SOC reaches the SOC threshold, suspending the charging of the solid-state battery during a suspension time acquired by referring to the map based on the SOC threshold; and

when the suspension time has elapsed, resuming the charging of the solid-state battery, and charging the solid-state battery until the SOC reaches an SOC threshold acquired by referring to the map based on the SOC at the resumption of charging.

By repeating continuous charging and discharging of the solid-state battery, uneven intercalation and deintercalation reactions of lithium ions occur in a positive electrode layer, which causes deterioration of the solid-state battery. According to (1), the processor refers to the map which is defined in advance, performs charging up to a range in which the continuous charging is allowed, and suspends the charging when the charging is out of the range. After the charging is resumed, the charging is performed within a range in which the continuous charging is allowed by referring to the map. Since the timing and the suspension time of charging suspension are appropriately set by the map based on the SOC, it is possible to equalize a lithium ion distribution in the positive electrode layer during the charging suspension while avoiding excessive charging suspension, and to suppress deterioration of the solid-state battery.

(2) The control device for the solid-state battery according to (1), in which

a plurality of the maps are provided, and

the processor further executes processing of selecting a map to be referred to according to a deterioration state of the solid-state battery.

According to (2), the timing and the suspension time of the charging suspension can be appropriately set according to the deterioration state of the solid-state battery, and the deterioration of the solid-state battery can be further suppressed.

(3) The control device for the solid-state battery according to (2), in which

the deterioration state depends on an ion conductivity of a positive electrode layer of the solid-state battery, and

the processor selects a map to be referred to according to the ion conductivity.

According to (3), the timing and the suspension time of the charging suspension can be appropriately set according to the ion conductivity of the positive electrode layer, and the deterioration of the solid-state battery can be further suppressed.

(4) The control device for the solid-state battery according to (2), in which

the deterioration state depends on a cumulative use time of the solid-state battery, and

the processor selects a map to be referred to according to the cumulative use time.

According to (4), the timing and the suspension time of the charging suspension can be appropriately set according to the cumulative use time of the solid-state battery, and the deterioration of the solid-state battery can be further suppressed.

(5) The control device for the solid-state battery according to (2), in which

the deterioration state depends on an open circuit voltage of the solid-state battery, and

the processor selects a map to be referred to according to the open circuit voltage.

According to (5), the timing and the suspension time of the charging suspension can be appropriately set according to the open circuit voltage of the solid-state battery, and the deterioration of the solid-state battery can be further suppressed.

(6) The control device for the solid-state battery according to any one of (1) to (5), in which

the processor is configured to control discharging of the solid-state battery by referring to another map (discharge control map) that is defined based on the SOC of the solid-state battery and indicates a range in which continuous discharging of the solid-state battery is allowed, and

in a case of discharging the solid-state battery, the processor executes processing of:

allowing discharging of the solid-state battery until the SOC of the solid-state battery reaches a discharging SOC threshold acquired by referring to the another map based on the SOC at the start of discharging; and

when the SOC reaches the discharging SOC threshold, restricting an output of the solid-state battery during a restriction time acquired by referring to the another map based on the discharging SOC threshold.

According to (6), by appropriately restricting continuous discharging by referring to the map based on the SOC, it is possible to suppress a progress of the uneven distribution of lithium ion reactions in the positive electrode layer, and to suppress the deterioration of the solid-state battery.

(7) The control device for the solid-state battery according to any one of (1) to (6), in which

the processor increases a restraint pressure of the solid-state battery while the charging of the solid-state battery is suspended.

According to (7), contact at an interface between the electrode layer and the solid electrolyte layer is improved, and thus the deterioration of the solid-state battery can be further suppressed.

(8) The control device for the solid-state battery according to any one of (1) to (7), in which

the processor adjusts a temperature of the solid-state battery while the charging of the solid-state battery is suspended.

According to (8), it is possible to promote movement of lithium ions and further suppress the deterioration of the solid-state battery.

(9) The control device for the solid-state battery according to any one of (1) to (8), in which

the processor is configured to select to continue charging without suspending the charging of the solid-state battery when the SOC reaches the SOC threshold, and

the processor is configured to:

accumulate, in the memory (memory 112), the number of times the charging of the solid-state battery is continued without suspending the charging; and

estimate a deterioration state of the solid-state battery based on the number of times accumulated in the memory.

According to (9), accuracy of deterioration estimation of the solid-state battery can be improved.

(10) A control method for a solid-state battery, the control method of controlling charging of the solid-state battery by an external power supply by referring to a map that is defined in advance based on an SOC of the solid-state battery and indicates a range in which continuous charging of the solid-state battery is allowed, the control method including:

charging the solid-state battery until the SOC of the solid-state battery reaches an SOC threshold acquired by referring to the map based on the SOC at the start of charging;

when the SOC reaches the SOC threshold, suspending the charging of the solid-state battery during a suspension time acquired by referring to the map based on the SOC threshold; and

when the suspension time has elapsed, resuming the charging of the solid-state battery, and charging the solid-state battery until the SOC reaches an SOC threshold acquired by referring to the map based on the SOC at the resumption of charging.

By repeating continuous charging and discharging of the solid-state battery, uneven intercalation and deintercalation reactions of lithium ions occur in a positive electrode layer, which causes deterioration of the solid-state battery. According to (10), the processor refers to the map which is defined in advance, performs charging up to a range in which the continuous charging is allowed, and suspends the charging when the charging is out of the range. After the charging is resumed, the charging is performed within a range in which the continuous charging is allowed by referring to the map. Since the timing and the suspension time of charging suspension are appropriately set by the map based on the SOC, it is possible to equalize a lithium ion distribution in the positive electrode layer during the charging suspension while avoiding excessive charging suspension, and to suppress deterioration of the solid-state battery.

What is claimed is:

1. A control device for a solid-state battery, the control device comprising:
a processor configured to control charging of the solid-state battery by referring to a map that is defined in advance based on an SOC of the solid-state battery and indicates a range in which continuous charging of the solid-state battery is allowed; and
a memory storing the map, wherein
in a case of charging the solid-state battery by an external power supply, the processor executes processing of:
charging the solid-state battery until the SOC of the solid-state battery reaches an SOC threshold acquired by referring to the map based on the SOC at the start of charging;
when the SOC reaches the SOC threshold, suspending the charging of the solid-state battery during a suspension time acquired by referring to the map based on the SOC threshold; and
when the suspension time has elapsed, resuming the charging of the solid-state battery, and charging the solid-state battery until the SOC reaches an SOC threshold acquired by referring to the map based on the SOC at the resumption of charging.

2. The control device for the solid-state battery according to claim 1, wherein
a plurality of the maps are provided, and
the processor further executes processing of selecting a map to be referred to according to a deterioration state of the solid-state battery.

3. The control device for the solid-state battery according to claim 2, wherein
the deterioration state depends on an ion conductivity of a positive electrode layer of the solid-state battery, and
the processor selects a map to be referred to according to the ion conductivity.

4. The control device for the solid-state battery according to claim 2, wherein
the deterioration state depends on a cumulative use time of the solid-state battery, and
the processor selects a map to be referred to according to the cumulative use time.

5. The control device for the solid-state battery according to claim 2, wherein
the deterioration state depends on an open circuit voltage of the solid-state battery, and
the processor selects a map to be referred to according to the open circuit voltage.

6. The control device for the solid-state battery according to claim 1, wherein
the processor is configured to control discharging of the solid-state battery by referring to another map that is defined based on the SOC of the solid-state battery and indicates a range in which continuous discharging of the solid-state battery is allowed, and
in a case of discharging the solid-state battery, the processor executes processing of:
allowing discharging of the solid-state battery until the SOC of the solid-state battery reaches a discharging SOC threshold acquired by referring to the another map based on the SOC at the start of discharging; and
when the SOC reaches the discharging SOC threshold, restricting an output of the solid-state battery during a restriction time acquired by referring to the another map based on the discharging SOC threshold.

7. The control device for the solid-state battery according to claim 1, wherein
the processor increases a restraint pressure of the solid-state battery while the charging of the solid-state battery is suspended.

8. The control device for the solid-state battery according to claim 1, wherein
the processor adjusts a temperature of the solid-state battery while the charging of the solid-state battery is suspended.

9. The control device for the solid-state battery according to claim 1, wherein
the processor is configured to select to continue charging without suspending the charging of the solid-state battery when the SOC reaches the SOC threshold, and
the processor is configured to:
accumulate, in the memory, a number of times the charging of the solid-state battery is continued without suspending the charging; and
estimate a deterioration state of the solid-state battery based on the number of times accumulated in the memory.

10. A control method for a solid-state battery, the control method of controlling charging of the solid-state battery by an external power supply by referring to a map that is defined in advance based on an SOC of the solid-state battery and indicates a range in which continuous charging of the solid-state battery is allowed, the control method comprising:
charging the solid-state battery until the SOC of the solid-state battery reaches an SOC threshold acquired by referring to the map based on the SOC at the start of charging;
when the SOC reaches the SOC threshold, suspending the charging of the solid-state battery during a suspension time acquired by referring to the map based on the SOC threshold; and
when the suspension time has elapsed, resuming the charging of the solid-state battery, and charging the solid-state battery until the SOC reaches an SOC threshold acquired by referring to the map based on the SOC at the resumption of charging.
